(19) United States
(12) Patent Application Publication
(10) Pub. No.: US 2002/0023582 A1
(43) Pub. Date: Feb. 28, 2002

(54) Apparatus for coating rotatable objects to be coated

(76) Inventor: Yoshio Kashihara, Osaka (JP)

Correspondence Address: KODA & ANDROLIA, Suite 3850, 2029 Century Park East, Los Angeles, CA, 90067-3024, US

(21) Appl. No.: 09/749,220

(22) Filed: Dec. 27, 2000

(30) Foreign Application Priority Data
Dec. 27, 1999 (JP) 11-370359

(51) Int. Cl. B05C 11/02

(52) U.S. Cl. 118/56; 118/319

(57) ABSTRACT

Apparatus for coating rotatable objects to be coated include a mechanism for forwarding a plurality of rotatable objects to be coated. The objects to be coated are forwarded rotatingly to receive paint flowing in a curtain form. Paint flowed down is accumulated for re-use. A gravitational shift of paint applied on the objects which is flowable after coating is used to rotate the objects and change an angle of the objects with respect to a horizontal plane so as to control movement of the flowable paint.

### FIELD OF THE INVENTION

The present invention relates to apparatus for coating rotatable objects to be coated.

### PRIOR ART

As a conventional method for coating ratable objects 41 to be coasted, such as cosmetic bottles and the like, is known a paint spray method. This method is illustrated in FIG. 12, wherein paint is atomized and sprayed onto a large number of cosmetic bottles and the like in sequence with a spray gun 42 and the like while the bottles are rotated in a vertical posture.

However, there is a problem in the conventional method. The method has a low efficiency in use of material paint to be sprayed and stay on the cosmetic bottles and the like, and about 70 to 80% of the total amount of the sprayed paint is wasted.

### SUMMARY OF THE INVENTION

It is hence an object of the present invention to provide an apparatus for coating rotatable objects to be coated in which the efficiency of use of material is improved.

In order to achieve the aforementioned object, the present invention takes the following technical means.

(1) An apparatus for coating rotatable objects to be coated includes a mechanism for forwarding a plurality of rotatable objects to be coated, in which the objects are rotatingly forwarded to receive a flow of paint in a curtain form. Paint flowed out is collected and re-used. Furthermore, the coating apparatus controls movement of paint by rotating the object to be coated and changing an angle of the object with respect to a horizontal plane by using a gravitational shift of paint adhered to the object which is flowable after coating.

The apparatus in which rotatable objects are forwarded to receive a paint flow in a curtain has advantage in collectability of paint for re-use over the cases where a spray gun or the like is used to spray atomized paint on objects to be coated.

Furthermore, the coating apparatus controls the movement of paint by rotating an object to be coated and changing an angle of the object with respect to a horizontal plane by using the gravitational shift of paint adhered to the object and flowable after coating. And therefore the thickness of paint coating can be adjusted uniform.

(2) The apparatus may have a mechanism for controlling the substantially horizontal self-rotation of the object and a mechanism for controlling the angle of the object with respect to the horizontal plane.

These mechanisms allow the control of the substantially horizontal self-rotation of the object during and after coating and before drying, and the angle of the same object with respect to the horizontal plane, depending on the size and shape of the object to be coated. And a substantially uniform coasting can be obtained on the object to be coated.

(3) The track of the forwarding mechanism of a plurality of rotatable objects may extend vertically to form a three-dimensional structure.

Since the track of the forwarding mechanism for drying and other purposes extends to form a three-dimensional structure, the apparatus can be installed in a relatively small space, and thereby allows an effective use of the floor area. In case where the objects are set to rotate substantially horizontal, not vertically, according to the relation of the direction of the track of the forwarding mechanism with respect to the rotational axis of the self-rotation of the object, it is easily understood that the apparatus may be built in a vertical structure.

(4) A coated object in the present invention is produced by the foregoing apparatus for coating rotatable objects to be coated.

### BRIEF DESCRIPTION OF THE DRAWINGS

FIG. 1 is an elevational view showing an overall three-dimensional structure of apparatus for coating rotatable objects to be coated according to one embodiment of the present invention;

FIG. 2 is a side view of the coating apparatus in FIG. 1;

FIG. 3 is an enlarged essential-portion perspective view of the coating apparatus in FIG. 1 wherein rotatable objects to be coated are rotatingly forwarded to receive paint flowing out in a curtain form;

FIG. 4 is a side view of the perspective view of FIG. 3;

FIG. 5 is a partial cross-sectional view of the coating apparatus in FIG. 1, showing structure for mounting an object to be coated to a forwarding mechanism;

FIG. 6 is an exploded partial perspective view of the coating apparatus in FIG. 1, showing structure for mounting the object to be coated to the forwarding mechanism;

FIG. 7 is a partial cross-sectional view of the coating apparatus in FIG. 1, showing a mechanism for controlling the substantially horizontal self-rotation of the object to be coated;

FIG. 8 is a view of the coating apparatus in FIG. 1, showing a mechanism for controlling an angle of the object to be coated with respect to a horizontal plane;

FIG. 9 is an exploded partial perspective view of the coating apparatus in FIG. 6, showing structure of another mounting fixture;

FIG. 10 is an enlarged view showing a state before the object to be coated is mounted to the mounting fixture of FIG. 9;

FIG. 11 is an enlarged view showing a state after the object to be coated is mounted to the mounting fixture of FIG. 9; and

FIG. 12 is a perspective view of a conventional spray-type coating apparatus.

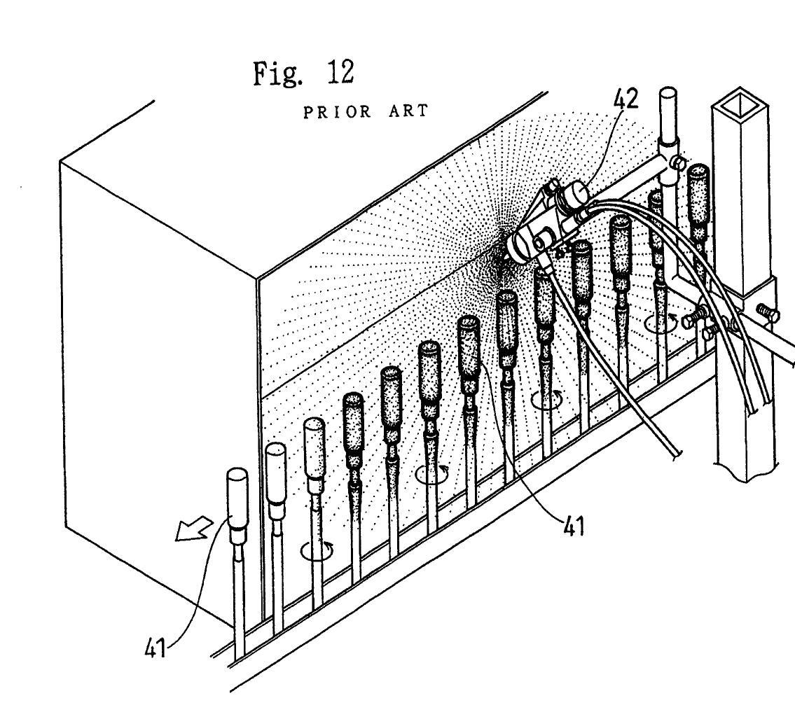

### DESCRIPTION OF THE PREFERRED EMBODIMENTS

The present invention will be described below with reference to the accompanying drawings showing preferred embodiments.

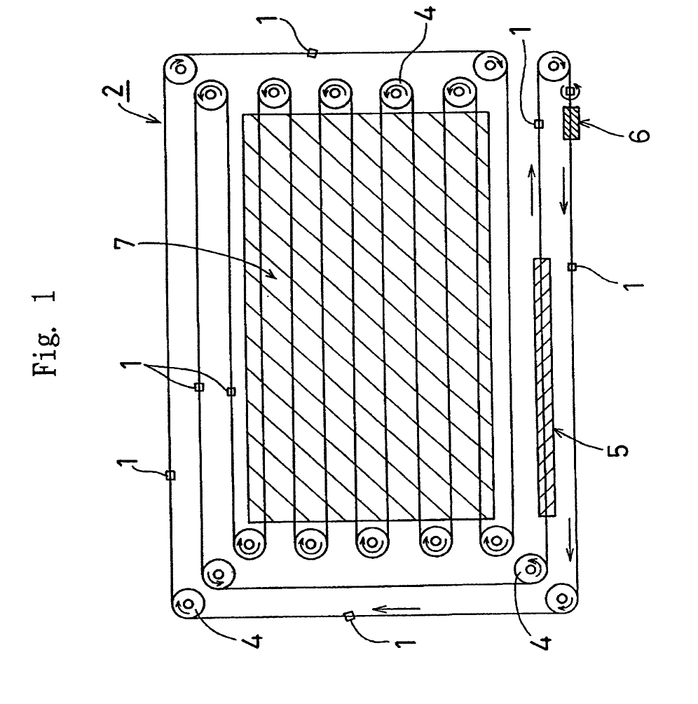

As shown in FIGS. 1 to 8, apparatus for coating rotatable object to be coated of an embodiment of the present invention includes a forwarding mechanism 2 for a plurality of objects 1 to be coated. Objects 1 to be coated include, for example, bottles. The forwarding mechanism 2 for objects 1 to be coated is formed as a loop-type forwarding mechanism having a chain 3.

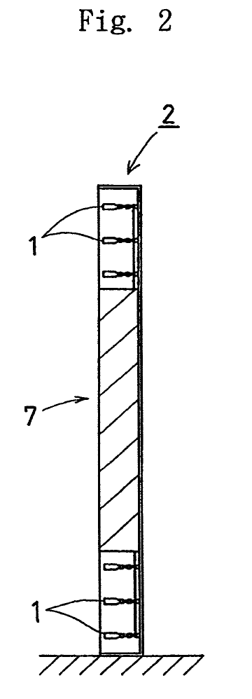

As shown in FIGS. 1 and 2, the forwarding mechanism 2 for objects to be coated (the loop-type forwarding mechanism with the chain 3) runs and forms a track in a three dimensional structure which extends vertically as a whole changing directions substantially perpendicular by chain sprockets wheels 4 and runs in the arrow directions.

The object 1 to be coated is mounted onto the forwarding mechanism 2 in a mounting section 5, and, in a coating section 6, the object 1 is rotated (self-rotated about its own axis) and forwarded to receive a flow of paint curtain. The object 1 that has been coated is further forwarded to a drying section 7 where a temperature can be increased from an ambient temperature to about 250 C. . . . , and the object 1 is dried therein. Finally, the object 1 is removed from the forwarding mechanism 2 again in the mounting section 5. Another object 1 to be subsequently coated is mounted on the forwarding mechanism 2.

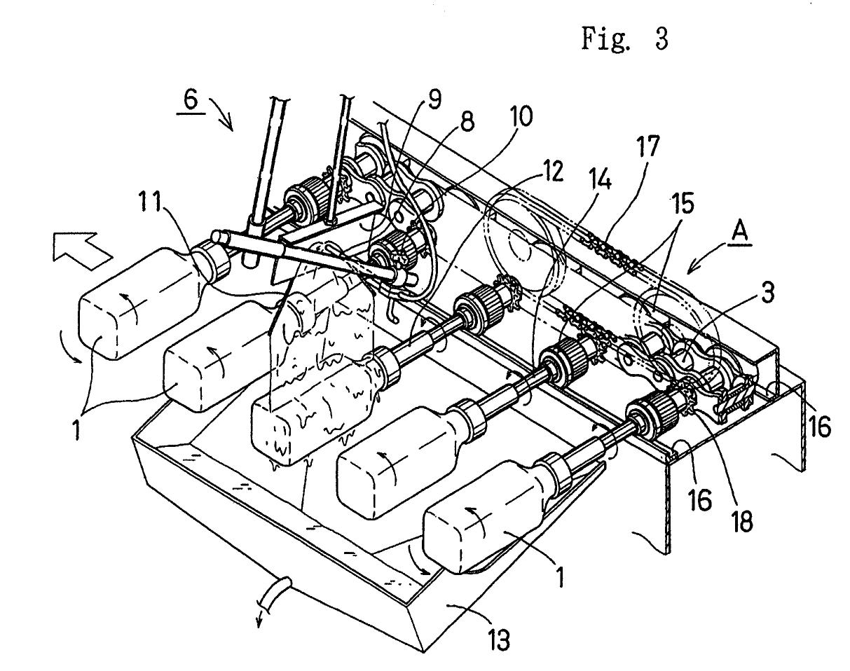

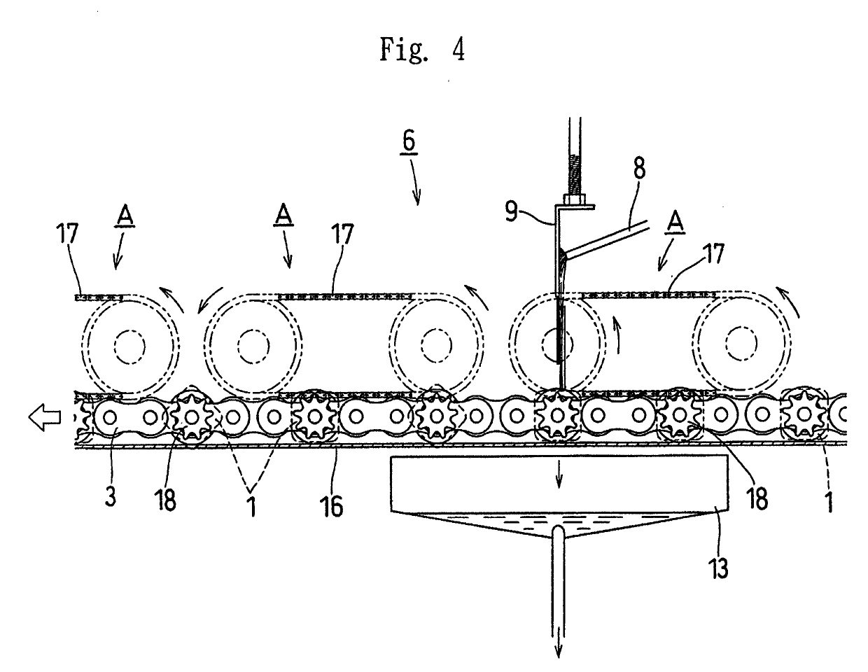

As shown in FIGS. 3 and 4, the object 1 to be coated is rotated (self-rotated on its own axis) and forwarded to receive a flow of paint curtain. And paint flowed down in a curtain form is collected to be reused. The “flow of paint curtain” denotes a state where paint flows down forming a curtain-like shape.

More specifically, paint flowed out from a pipe 8 impinge on a stainless plate 9 and splashes back spreading and forming a curtain-like shape. The angle of the pipe 8 with respect to the stainless plate 9 is adjusted to about 20 . . . with respect to a horizontal plane. The amount of paint to be supplied is adjusted with a valve 10. The spread of the paint curtain can be adjusted by setting the distance between the pipe 8 and the stainless plate 9. Paint is controlled to flow down in a curtain form along a guide of metal wires 11 disposed in the left and right sides. Adjustment of the metal wires 11 allows a range of spread of a paint curtain to be applied on the object 1 not to reach a mounting fixture 12.

Paint that does not stay on the object 1 and flows down is accumulated in a collecting box 13, and then is re-circulated by a pump (not shown).

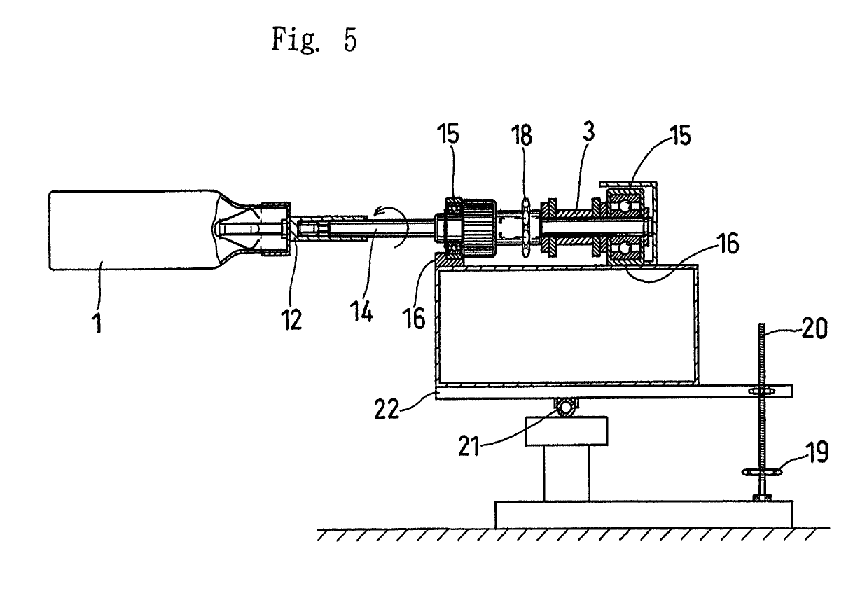

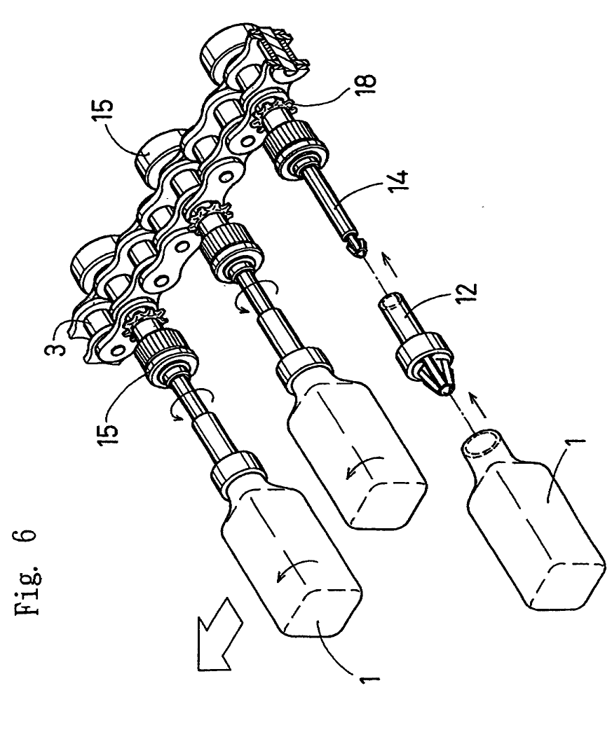

As shown in FIGS. 5 and 6, the object 1 to be coated is mounted, through the mounting fixture 12, on a mounting shaft 14 of the chain 3 of the forwarding mechanism 2. The mounting shaft 14 for the object 1 to be coated houses a pair of bearings 15, through which the shaft 14 is forwarded on the passage shown in FIGS. 1 and 2 three-dimensionally along a guide plate 16.

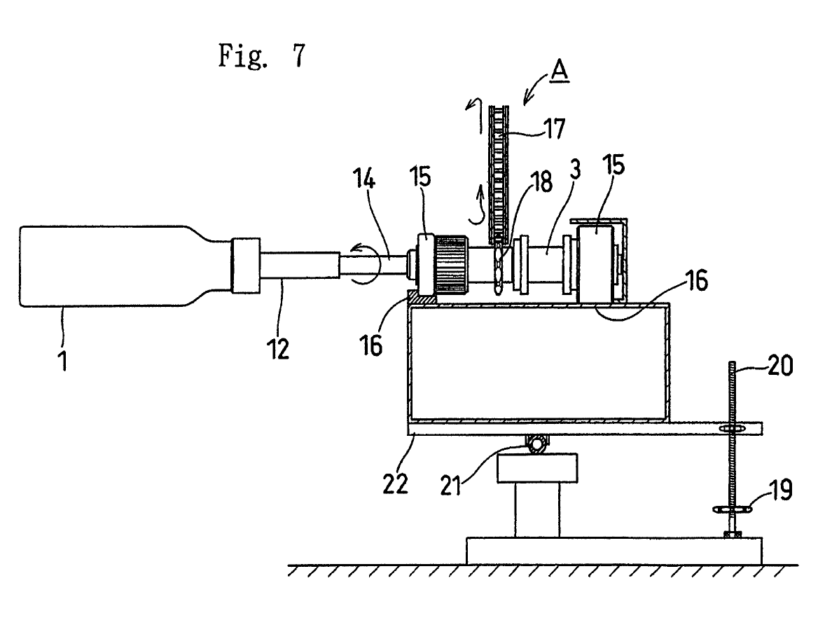

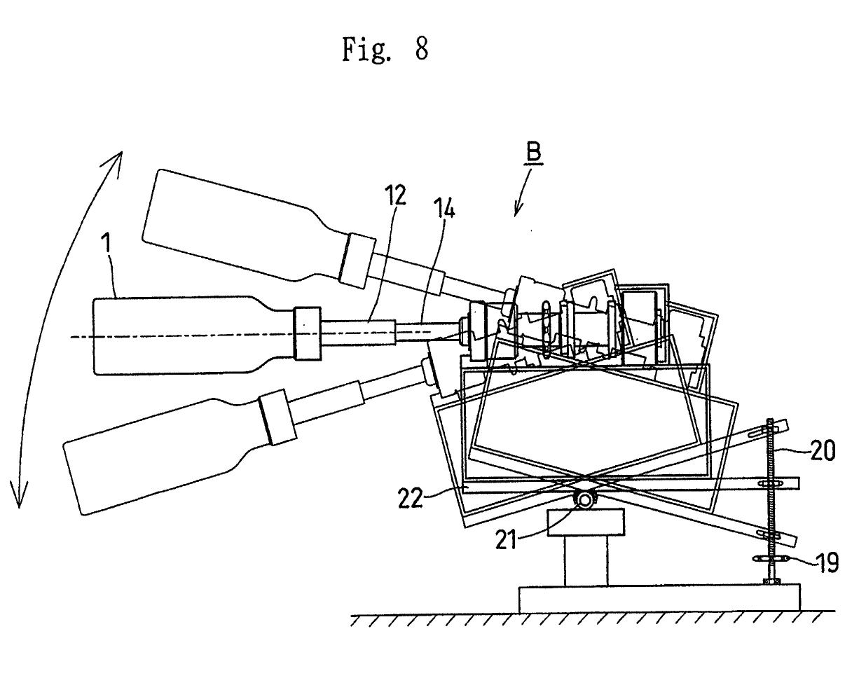

In addition, as shown in FIGS. 7 and 8, the apparatus is provided with a mechanism A for controlling the substantially horizontal self-rotation of the object 1 (i.e. self-rotation in a horizontal posture) and a mechanism B for controlling an angle of the object 1 with respect to the horizontal plane.

As shown in FIGS. 7, 3 and 4, the mechanism A for controlling the substantially horizontal self-rotation of the object 1 has a chain 17 for driving the object 1 to rotate and a gear 18 formed on the circumference of the mounting shaft 14 of the chain 3. The gear 18 is driven by the chain 17 to force the object 1 to rotate about its own axis. Therefore, the rotation of the object 1 is controlled, such as to rotate forward or reverse or to set a certain rotation rate, so that the object 1 has a uniform coat thereon.

FIG. 8 shows the mechanism B for controlling an angle of the object 1 with respect to a horizontal plane. In the control mechanism B, a gear 19 is driven with a motor (not shown) to rotate a threaded shaft 20 and thereby to oscillate a table 22 up and down about a fulcrum 21 (formed of a round bar). The table 22 is movable from side to side by means of a nut. With these parts, the angle (the range of oscillation is electrically set between 25 . . . upwardly and 25 . . . downwardly with respect to the horizontal plane) is controlled so that the object 1 has a uniform coat thereon.

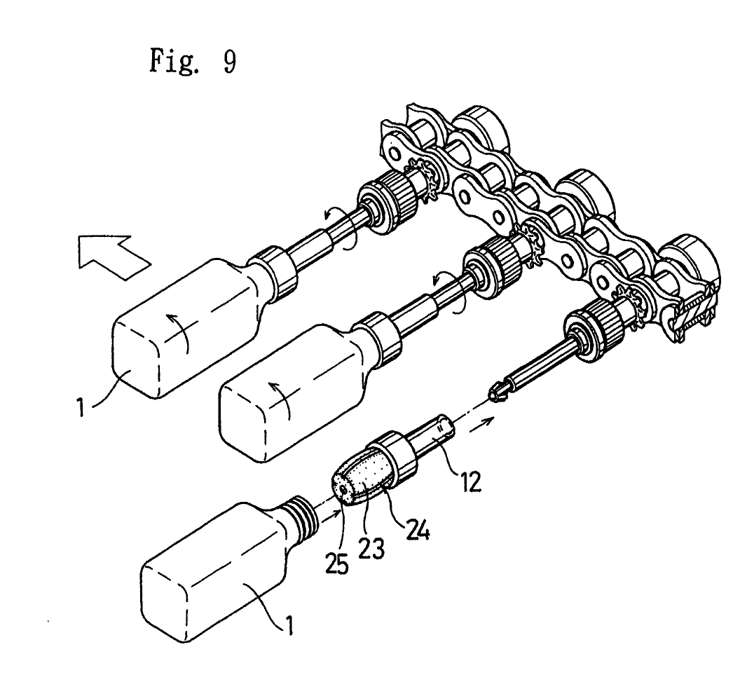

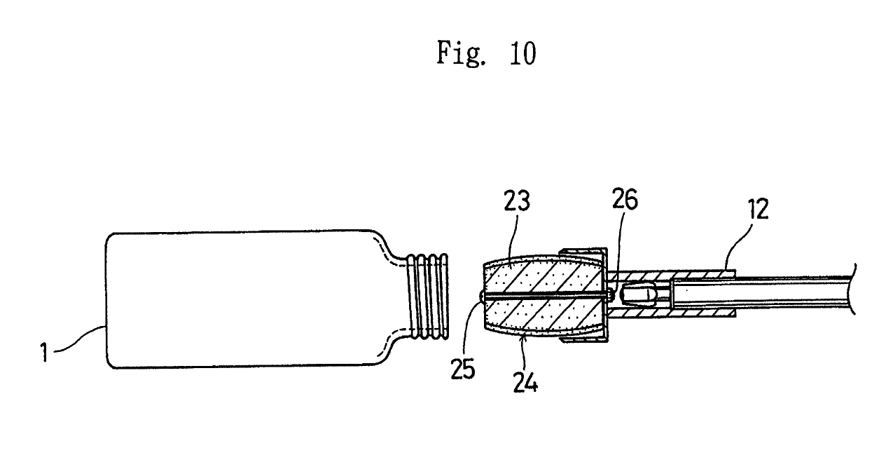

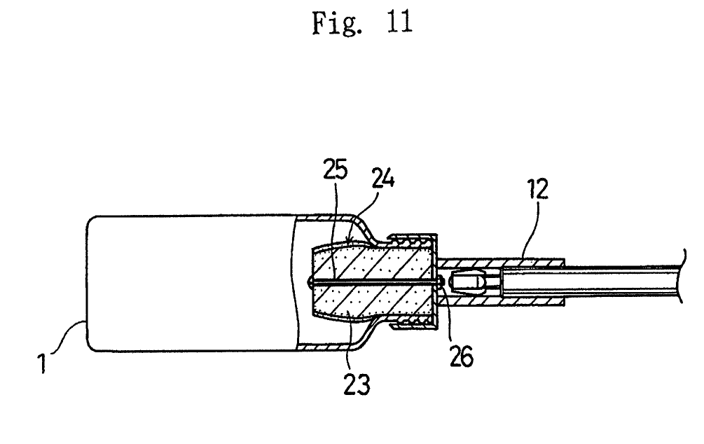

As shown in FIGS. 9 to 11, an insertion member 23 made of heat-resisting silicone resin may be disposed on a side receiving the object 1 of the mounting fixture 12. The insertion member 23 of heat-resisting silicone resin is shaped cylindrically with four cutout grooves 24 on its circumference at equal intervals and compressed from its both ends by fastening a screw 25 and a nut 26 (see FIGS. 10 and 11) to bulge a central portion out.

The insertion member 23 of heat-resisting silicone resin preferably secures holding of the object 1 to be coated. The object 1, or a bottle, can be held on an inner side of its opening (there might be a difference in size between bottles to be held of about 0.1 to 3.0 mm).

Under the coating process, the object 1 to be coated is self-rotated and, by controlling the speed of substantially horizontal rotation of the object 1 and the angle of the object 1 with respect to the horizontal plane, the objects is coated uniform.

Specifically, the paint adhered to the object 1 has flowability after being applied and before being dried, and tends to move downwardly by its own weight. The movement of the paint on the object 1 is controlled by rotating the object 1 to be coated or changing the angle with respect to the horizontal plane by using the gravitational shift of the paint so as to adjust the thickness of coating of paint to be uniform. A faster rotation of the object 1 to be coated during the coating process can adjust the coating on the object 1 thinner.

With the adjustment and control as stated above, the object 1 to be coated, or a square bottle shown in the drawings and having a substantially square section (having a dent or a protrusion), could have a substantially uniform coating thereon. The bottom portion having a dent could also obtain a uniform coating. In case the object 1 to be coated is a round bottle having a substantially circular section, with only one single rotation of the object with respect of the paint curtain during the coating process, the object could have a substantially uniform coating thereon.

The conventional spray-type coating method provides only simple monochromatic painting, but cannot provide patterns. However, the embodiment of the present invention allows to automatically manufacture painted articles with a variety of patterns (such as marble-like patterns (not shown)) by, for example, controlling the angle.

The use of the apparatus for coating objects to be coated according to an embodiment of the present invention is described below.

In the apparatus of the embodiment, rotatable objects 1 to be coated are forwarded to receive paint flowing in a curtain form. Therefore, collectability of paint for reuse in the present invention is significantly higher than in the cases where a spray gun or the like is used to spray atomized paint on objects 1 to be coated. Thus, compared to the conventional cases, efficiency in material use is enhanced in the present invention.

Specifically, paint that does not stay on objects 1 and flows down is accumulated in the collecting box 13, and such accumulated paint is re-circulated by a pump (not shown). Therefore, paint can be substantially used up 100%, thereby resulting in effective use of resources. In addition, compared to the conventional spray-type method, the amount of wasted paint can be reduced to 1/10 or less and, since almost no paint refuse is produced, the apparatus of this embodiment can be said environmentally friendly.

Conventionally, when objects to be coated are rotated vertically (in a vertical posture) and spray-coated, paint is sprayed on a fixture for mounting an object on a rotation axis, or paint gradually drops down to form a coating on the fixture. However, in the embodiment, it is adjustable that paint does not reach the fixture 12 which supports an object to be coated rotating substantially horizontal (in a horizontal posture). Therefore cumbersome removal of the coating on the fixture is advantageously eliminated.

Also, the apparatus according to the present invention includes the mechanism A for controlling the substantially horizontal self-rotation of the object 1 and the mechanism B for controlling the angle of the object 1 with respect to the horizontal plane. Therefore, during coating or after coating and before drying, the substantially horizontal rotation and the angle with the horizontal plane of the object 1 are controlled depending on the size and the shape of the object 1 so as to provide a substantially uniform coating on the object 1.

In addition, the track of the forwarding mechanism used for drying and other purposes is three-dimensionally formed extending vertically as a whole. Therefore, the apparatus can be advantageously installed in a relatively small floor space, thereby resulting in effective use of floor space. In the embodiment, the coating object 1 is set to self-rotate in a substantially horizontal posture, not in a vertical posture. According to the relation of the direction of the track of the forwarding mechanism (a vertical direction) with respect to the self-rotational axis of the object, the apparatus can be vertically structured easily.

In the conventional paint spray method, the self-rotational axis of an object to be coated is vertical. Traveling other than along the horizontal plane is difficult in view of the time and the traveling distance for drying after coating. As a result, the conventional method requires a wide working space. On the other hand, in the embodiment of the present invention, the apparatus requires only a space of the bottom area X the height of the apparatus to be installed. Therefore, within about a 1/10 or smaller space than the conventional floor space, the apparatus can be installed three-dimensionally (vertically).

The present invention is constructed as described above, and has the following advantages.

The collectability of paint for re-use is significantly higher than in the cases where a spray gun or the like is used to spray atomized paint onto objects. Thus, the apparatus for coating rotatable objects to be coated of the present invention can improve the efficiency in use of material.

Furthermore, the coating apparatus of the present invention uses the gravitational shift of paint adhered to the object with flowability after coating to control the movement of the paint by rotating the object and changing the angle of the object with respect to the horizontal plane. Therefore the thickness of coating can be adjusted uniform.

What is claimed is:

1. Apparatus for coating rotatable objects to be coated comprising:
a mechanism for forwarding a plurality of rotatable objects to be coated, in which said objects are forwarded rotatingly to receive paint flowing in a curtain form; and
wherein paint flowed down is accumulated for re-use, and a gravitational shift of paint applied on said objects which is flowable after coating is used to rotate said objects and change an angle of said objects with respect to a horizontal plane so as to control movement of said flowable paint.

2. Apparatus for coating rotatable objects to be coated according to claim 1, further comprising a mechanism for controlling a substantially horizontal self-rotation of said objects and a mechanism for controlling an angle of said objects with respect to a horizontal plane.

3. Apparatus for coating rotatable objects to be coated according to claim 1 wherein a track of said forwarding mechanism for a plurality of rotatable objects to be coated extends substantially vertically to form a three-dimensional structure.

4. Coated objects produced by means of the apparatus for coating rotatable objects to be coated according to claim 1.
